(19) United States
(12) Patent Application Publication
(10) Pub. No.: US 2015/0081521 A1
(43) Pub. Date: Mar. 19, 2015

(54) SYSTEMS, METHODS AND COMPUTER PROGRAM PRODUCTS FOR MANAGING CREDIT APPLICATION DATA

(71) Applicants: Myles Kenneth Leighton, Durham, NC (US); Curt Daniel Szymanski, Waunakee, WI (US)

(72) Inventors: Myles Kenneth Leighton, Durham, NC (US); Curt Daniel Szymanski, Waunakee, WI (US)

(21) Appl. No.: 14/186,128

(22) Filed: Feb. 21, 2014

Related U.S. Application Data
(60) Provisional application No. 61/878,676, filed on Sep. 17, 2013.

(51) Int. Cl. G06Q 40/02

(52) U.S. Cl. CPC G06Q 40/025
USPC 705/38

(57) ABSTRACT

Provided are methods, systems and computer program products of aggregating data with minimal data entry to create, format, share, merge, securely store, update, and display affordability with reason of a credit application on a mobile device and website. Such methods, systems and computer program products may be directed to gathering all of the data for an application for the user.

### RELATED APPLICATIONS

This non-provisional patent application claims priority to U.S. Provisional Application Ser. No. 61/878,676, filed Sep. 17, 2013, the disclosure of which is hereby incorporated herein by reference as if set forth fully herein.

### BACKGROUND

Consumer loan applications may be completed manually and may often have many fields, each of which may require highly specific information that may be misstated and/or over-generalized. For example, gathering all of the data for an application may be time consuming and may introduce error in the data. Additionally, the gathered data may include a variety and discontinuity that provide no meaningful or readily discernible information regarding credit eligibility or purchasing power. Yet further, credit application processes may involve the completion and submission of different and/or duplicitous forms and/or documents, which may be confusing, tedious and/or time consuming.

### BRIEF SUMMARY

Some embodiments of the present invention are directed to a computer system that includes a processor and a memory coupled to the processor. The memory may include computer readable program code embodied therein that, when executed by the processor, causes the processor to aggregate user information through a plurality of validated external sources and generate a credit application having a standard format using the user information.

In some embodiments, aggregating the user information includes receiving, via a user interface, a user input that includes less than three fields of data or that comprises a social network login. Some embodiments include transmitting a request by the computer system to the social network to receive personal user data from the social network. In some embodiments, aggregating the user information includes aggregating personal data in a primary aggregating operation corresponding to user provided information or social network information and aggregating secondary data in a secondary aggregating operation that is different from the primary aggregating operation.

In some embodiments, aggregating secondary data in a secondary aggregating operation includes requesting data from a plurality of external data sources, further comprising sorting and matching aggregated data into standard data fields. Some embodiments include, before generating the credit application, generating a user data file corresponding to the aggregated data and storing the user data file in a provider data repository. In some embodiments, generating the credit application includes receiving, via a user interface, a form selection input corresponding to which type of a plurality of forms to use for the credit application. Some embodiments include generating a form corresponding to a certification form responsive to receiving the form selection input and transmitting, displaying and/or printing the certification form.

In some embodiments, generating the credit application includes receiving, via a user interface, an application selection input corresponding to which of multiple credit application types to generate for the credit application. Embodiments may further include generating the credit application responsive to receiving the application selection input and transmitting, printing and/or displaying the generated credit application.

In some embodiments, generating the credit application includes receiving an affordability analysis input from the user via a user interface and generating an affordability analysis corresponding to the user data file and a credit application type. Some embodiments provide that the affordability analysis includes at least one suggestion for improving an affordability characteristic. Embodiments may further include printing and/or displaying the at least one suggestion.

Some embodiments include receiving, via a graphical user interface, a user input to share the credit application, sending an invitation to a co-borrower to join the credit application, receiving co-borrower data and merging the user information and the co-borrower data to generate a shared credit application.

Some embodiments include a mobile terminal comprising a mobile terminal processor and a mobile terminal memory coupled to the mobile terminal processor, the mobile terminal memory comprising computer readable program code embodied therein that, when executed by the processor, causes the processor to perform one or more operations disclosed herein.

Some embodiments of the present invention include methods that include aggregating user information through a plurality of validated external sources and generating a credit application having a standard format using the user information. In some embodiments, aggregating user information and generating the credit application are performed using at least one processor.

In some embodiments, aggregating the user information includes receiving, via a user interface, a user input that includes less than three fields of data or that includes a social network login. Some embodiments include transmitting a request by the computer system to the social network and receiving personal user data from the social network in response to the request.

In some embodiments, aggregating the user information includes aggregating personal data in a primary aggregating operation corresponding to user provided information or social network information and aggregating secondary data in a secondary aggregating operation that is different from the primary aggregating operation and that includes transmitting requests and receiving data from a credit data repository, the Internal Revenue Service and/or an Office of Foreign Asset Control data repository.

Some embodiments include, before generating the credit application, generating a user data file corresponding to the aggregated data and storing the user data file in a provider data repository. In some embodiments, generating the credit application includes receiving, via a user interface, a form selection input corresponding to which type of a plurality of forms to use for the credit application. Some embodiments provide that receiving the form selection input includes receiving a first form selection input and a second form selection input. Embodiments may further include generating a first form corresponding to a first certification form responsive to receiving the first form selection input, generating a second form that is different from the first form and that corresponds to a second certification form that is different from the first certification form responsive to receiving the second form selection input and transmitting, displaying and/or printing the first and/or second certification form.

In some embodiments, generating the credit application includes receiving, via a user interface, an application selection input corresponding to which one of a plurality of credit application types to generate for the credit application. Embodiments may include generating the credit application responsive to receiving the application selection input and transmitting, printing and/or displaying the generated credit application.

In some embodiments, generating the credit application includes receiving an affordability analysis input from the user via a user interface and generating an affordability analysis corresponding to the user data file and a credit application type. Some embodiments provide that the affordability analysis includes at least one suggestion for improving an affordability characteristic. The at least one suggestion may be printed and/or displayed.

Some embodiments include receiving, via a graphical user interface, a user input to share the credit application, sending an invitation to a co-borrower to join the credit application, receiving co-borrower data and merging the user information and the co-borrower data to generate a shared credit application.

Some embodiments of the present invention include a computer program product including a computer readable storage medium having computer readable code embodied in the medium. The computer readable code may perform operations including aggregating user information through a plurality of validated external sources, generating a user data file corresponding to the aggregated data, generating a plurality of different credit applications corresponding to different types of goods to be purchased using credit, receiving an affordability analysis input from the user, generating an affordability analysis corresponding to the user data file, the affordability analysis input and a credit application type, wherein the affordability analysis includes at least one suggestion for improving an affordability characteristic, storing the user data file, at least one credit application and the affordability analysis in a provider data repository, and transmitting, printing and/or displaying the generated credit application and/or the affordability analysis.

It is noted that aspects described with respect to one embodiment may be incorporated in different embodiments although not specifically described relative thereto. That is, all embodiments and/or features of any embodiments can be combined in any way and/or combination. Moreover, other systems, methods, and/or computer program products according to embodiments will be or become apparent to one with skill in the art upon review of the following drawings and detailed description. It is intended that all such additional systems, methods, and/or computer program products be included within this description, be within the scope of the present inventive concept, and be protected by the accompanying claims.

### BRIEF DESCRIPTION OF THE DRAWINGS

Aspects of the present disclosure are illustrated by way of example and are not limited by the accompanying figures with like references indicating like elements.

FIG. 1 is a block diagram illustrating operations and structures for credit application data gathering and aggregation according to some embodiments of the present inventive subject matter.

FIG. 2 is a graphically enhanced block diagram illustrating operations and structures for the affordability, credit limit and/or buying power results corresponding to an application generated according some embodiments of the present inventive subject matter.

FIG. 3 is a block diagram illustrating operations and structures for applicant actions corresponding to an application according to some embodiments of the present inventive subject matter.

FIG. 4 illustrates a virtual computing environment according to some embodiments of the present inventive subject matter.

FIG. 5 illustrates a virtual computing environment according to some embodiments of the present inventive subject matter.

FIG. 6 is a block diagram illustrating an example list of data fields that may be populated and corresponding prospective data sources and/or data types that may be used in some embodiments of the present inventive subject matter.

### DETAILED DESCRIPTION

Some embodiments described herein may automatically aggregate the data for multiple different fields of a consumer and/or mortgage credit application with one click of a social login or with two fields of information. For example, some non-limiting embodiments provide that such fields include the name and city of the applicant.

In some embodiments, embodiments disclosed herein may format the aggregated data into various application types, such as a general application, automobile purchase loan application, and/or a mortgage, among others. Some embodiments provide that the user may update the data, share and save the application responsive to very basic user inputs, such as one or more clicks of a mouse or other user interface input. In some embodiments, the primary application may be used to invite a co-borrower.

Some embodiments provide that a summary of what the applicant can afford with their current credit may be displayed and/or otherwise provided. Additionally, information on what the applicant can do to improve their buying power and terms may also be generated and/or provided to an applicant. In this manner, an applicant or prospective application may be made aware of present credit-buying capabilities.

Some embodiments disclosed herein may maintain, format and/or enable sharing of a completed or partially completed application to make subsequent applications more easy to complete, more accurate, and more readily available without having to complete or fully complete subsequent loan applications again. In some embodiments, parties receiving applications that are generated according to embodiments herein may experience high confidence levels regarding the accuracy and completeness of the application, as well as credit and/or buying power limitations, which may save time and reduce the potential for fraud.

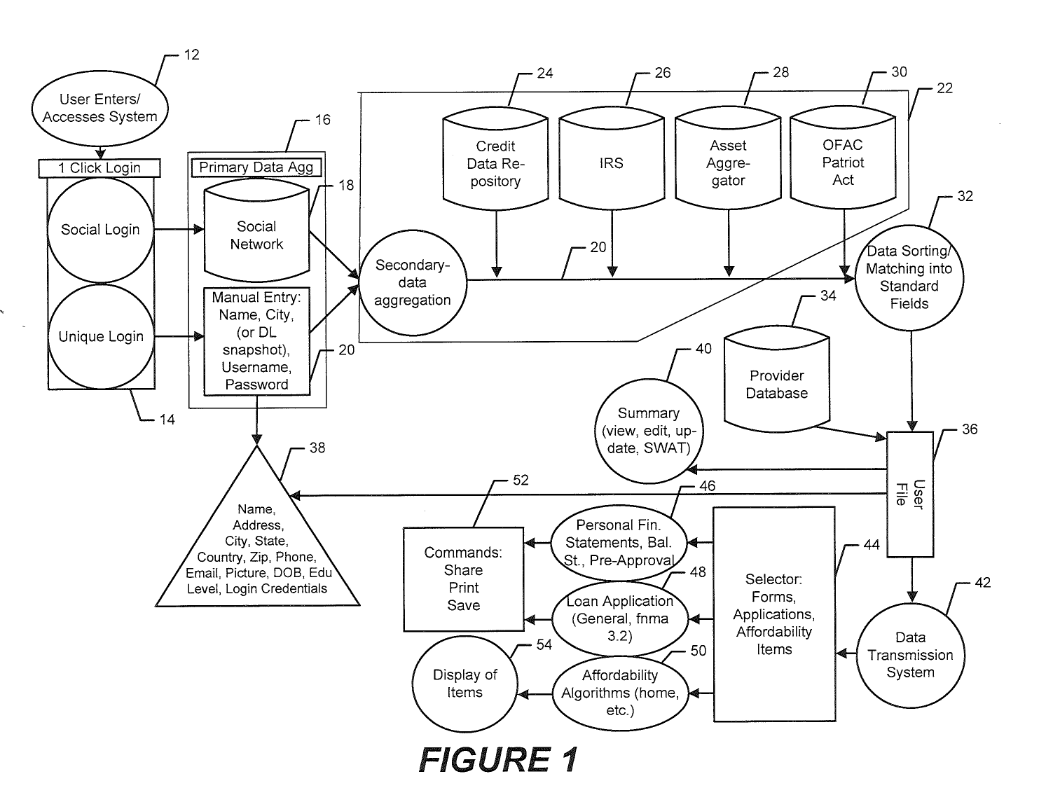

Reference is now made to FIG. 1, which is a block diagram illustrating operations and structures for credit application data gathering and aggregation according to some embodiments of the present invention. In some embodiments, a user may enter and/or access a system or portion thereof (block 12). Some embodiments provide that an expedited login process may be performed as a one-click login (block 14) that may be performed using pre-existing social media/network login processes and interfaces. Once logged in to a social network 18 or the like, a request is sent to the social media/network and/or host thereof for all information related to the personal information of the user, including but not limited to the name and city of the user.

In some embodiments, the login may be performed by providing a unique login, such as a unique combination of any number of different data corresponding to a user. For example, combinations of name, city of residence, city of birth, username, password, and/or an identification document image, such as, a photograph of a drivers license may be used for embodiments disclosed herein (block 20). Some embodiments provide that the unique login does not use a call to a host.

After logging in, primary data aggregation may be performed (block 16). In some embodiments, a request for authorization may be sent to the user to build a corresponding credit file. The request for authorization may include one or more notice provisions that may inform the user of consequences, actions and/or ramifications, if any, of building the credit profile.

A secondary data aggregation process 22 may be performed. In some embodiments, the secondary information may include operations for requesting and/or receiving information and/or data from multiple different data repositories including, but not limited to a credit repository 24, the Internal Revenue Service 26, an external asset aggregator 28 and/or an Office of Foreign Asset Control (OFAC)/Patriot Act repository, among others. In this manner, accurate data corresponding to remaining fields in one or more different application formats may be gathered. The gathered data may be sorted and/or matched into one or more standard data fields (block 32).

Using the sorted and matched data, a user file 36 may be generated, populated and/or updated. In some embodiments, the user file 36 and corresponding data may be used to populate a provider database 34. Some embodiments provide that some of the data in the user files 36 may be received from the provider database 34. The user may be presented with a summary that includes the data fields that have been filled and may be given the opportunity view, edit, update and/or SWAT (block 40). The information may be saved in the provider database 34 in a core file corresponding to the user.

In some embodiments, a data transmission system may send the user file 36, data therein and/or portions thereof to a selector 44 through which various operations may be selected. For example, one or more forms may be selected (block 46). Forms may include personal financial statements, balance statements and/or pre-approval documents, among others. Some embodiments provide that applications 48 may be selected. Applications may include various types of loan applications, pre-qualification applications, and/or mortgage applications, among others. The forms 46 and/or applications 48 may be used in a variety of ways once selected. For example, such operations may include commands such as sharing, printing and/or saving, among others (block 52).

Some embodiments provide that the selector 44 may select one or more affordability functions 50. Affordability functions may include algorithms that determine credit recommendations and/or limits corresponding to various types of purchases, such as real estate, automobiles and/or consumer credit purchasing power. In some embodiments, the results of the users credit profile may be displayed with respect to what the user can afford in terms of popular large ticket items, such as a house, car, boat, or airplane. Some embodiments provide that hints may be displayed to the user regarding how to improve the rate, terms, and buying power of what they seek.

In some embodiments, an option to merge application information with that of another may be presented to a user. For example, a dual (borrower+co-borrower) application may be generated and saved.

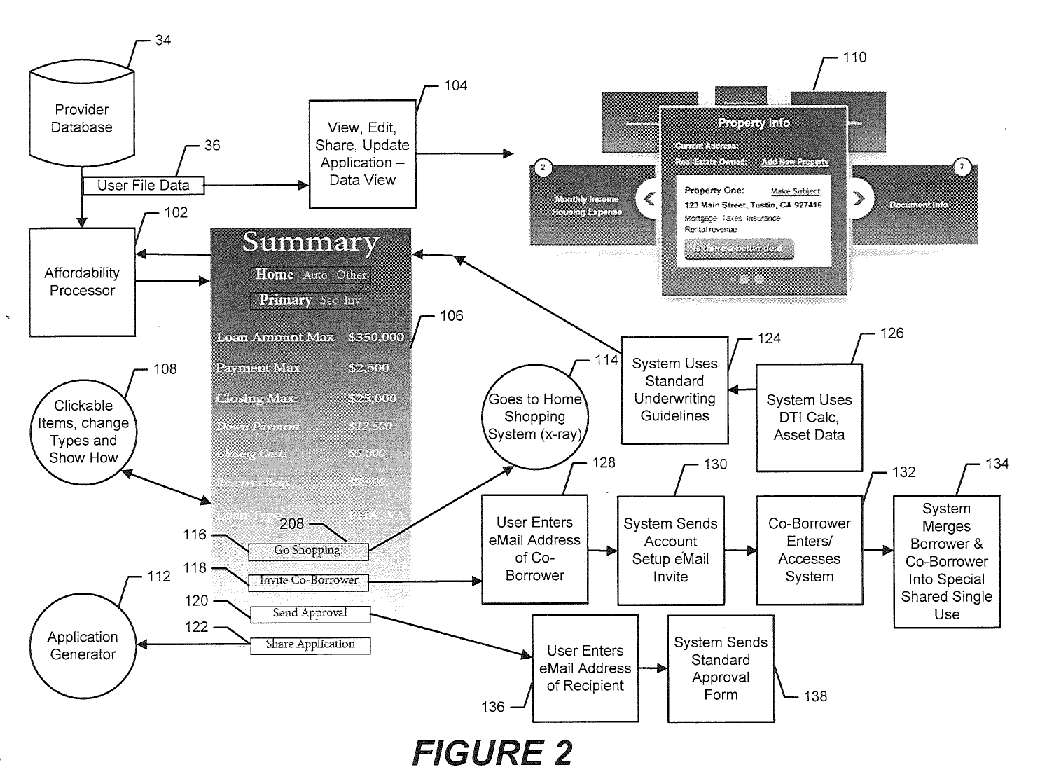

Reference is now made to FIG. 2, which is a graphically enhanced block diagram illustrating operations and structures for the affordability, credit limit and/or buying power results corresponding to an application generated according some embodiments of the present invention. A provider database 34 may store and provide access to a user data file 36. An affordability processor 120 that may include the affordability functions that may determine credit recommendations and/or limits corresponding to various types of purchases, such as real estate, automobiles and/or consumer credit purchasing power.

An affordability summary 106 may be displayed or otherwise provided to the user. The affordability summary 106 may include multiple screens corresponding to different types of assets and/or classes thereof. Each of the screens may include data relevant to the type of asset and/or asset class. For example, asset types may include, home, auto and other. In some embodiments, the asset classes may be different for each asset type. For example, for home assets, the asset classes may be primary residence, second home, commercial property, and/or investment property, among others. Similarly, for auto assets, the asset classes may be primary, secondary, recreational, commercial, and/or hobby among others. The affordability summary 106 may include value limits corresponding to different costs and lending requirements based on the user credit profile.

The affordability summary 106 be provided in a graphical user interface (GUI) that includes buttons and/or other GUI controls that may be actuated by a user to access other functions. The buttons may include software generated portions of the display that are configured to be selected by a user using a pointer interface (e.g., mouse, trackball, stylus, etc.), a touch screen display and/or a portion of the display that identifies a switch or other physical user interface input. For example a go shopping button 116 may launch an application for a shopping system, service and/or interface corresponding to the asset type (block 114).

An invite co-borrower button 118 may launch an operation for inviting a co-borrower for the corresponding application. In some embodiments, inviting the co-borrower may include entering an email address or other identifier corresponding to a prospective co-borrower (block 128). An account setup invitation may be sent to the prospective co-borrower via email or other communication means and/or channels (block 130). The prospective co-borrower may provide input data to enter the process and/or have a user file created and/or updated (block 132). The user and co-borrower data may be merged to generate a shared single use user data file for the corresponding application (block 134).

In some embodiments, an email address or pre-saved co-applicant may be provided by the user, to message the secondary applicant to join a joint credit file with the user. If the secondary applicant accepts, the system merges the data of both parties and saves the file as a new joint file. Some embodiments provide that this joint file may lock after one submission or sharing. Some embodiments provide that the results may show the maximum limits of what the user can buy, what they have available for a down payment, and what they should keep for reserves.

Some embodiments provide that, to prevent or reduce a risk of fraud, the user cannot change the amount of any field variable without using their mobile camera or scanner to upload supporting docs, which may then be scanned by the system to add or update the information in the user file data. In some embodiments, optical character recognition (OCR) technology may be used to identify the field of a standard form, such as a W2, and/or the numerical or textual value associated with the field. If the form comes from a new source, such as second employer, a related field may be added and/or generated. Otherwise the existing field may be updated if it matches the existing field source.

A send approval button 120 may launch an operation for sending a communication corresponding to loan or credit application approval. The user may provide an email address or other identifier corresponding to an intended recipient (block 136). An approval form may be generated and/or sent to the recipient (block 138).

Some embodiments provide that once the core data has been obtained and checked by the user, the user may be presented and/or provided with options for managing the data. In some embodiments, the user can request to update the core data, using one or more user input methodologies disclosed herein, including, for example, a one-click user interface. In response, new requests to the data sources may be generated and/or transmitted.

Some embodiments provide that portions of the data in the user file may have a high value based on recency. For example, some data may be considered less useful and thus stale after a given time period has elapsed since the data was received and/or generated. In some embodiments, one or more reminders may be sent to a user to update the data at given time intervals. For example, some embodiments provide that an update reminder may be generated and/or sent every thirty days, but such embodiments are non-limiting examples. For instance, the reminder time interval may be some number of day less than or more than thirty days. Additionally, the reminder time interval may vary based on the types of data corresponding thereto. For example, one data type may be considered less useful after thirty days whereas another data type may not lose value for 90 days. In this regard, the reminder time intervals may vary based on the data type.

Some embodiments provide that the user can request with one click to share the application with a list of verified business recipients. A link to the application may be sent to the listed recipient. If a recipient is not listed, the user can input the name, business, and email address of the recipient, and an invitation may be sent to the recipient to join the platform. The recipient may then undergo a series of validations to be approved.

In some embodiments, the appropriate standard application format may be selected and/or pre-selected based on the user's purchasing goals. For example, if the user wants to purchase real estate with this credit application, the application may be formatted to a standard mortgage file format, including, but not limited to a FNMA 3.2 file format.

Some embodiments provide that a secure storage file with the highest-level available security standards may be used to store core data, sent applications, and saved joint applications. Additionally, supporting documents may be stored in the file, such as IRS 4506 forms, bank statements and/or W2's, among others. Some embodiments provide that the user may selectively and/or completely delete stored documents in this folder.

In some embodiments, a variety of different user driven functions may be performed. For example, the user file data 36 may be viewed, edited, shared, and updated (block 104). For example, the share function may format the application data into an application format of the user's choice and then send a link (e.g., email, sms, etc.) to a vendor to view the application and/or upload the application into the vendor system. Additionally, the data may be updated by requesting update data from one or more formal databases (e.g., TransUnion, IRS, etc.) and update the user file based on data received responsive to the request. Some embodiments include a user interface 110 of user file data that may be used to perform the user driven functions described in block 104.

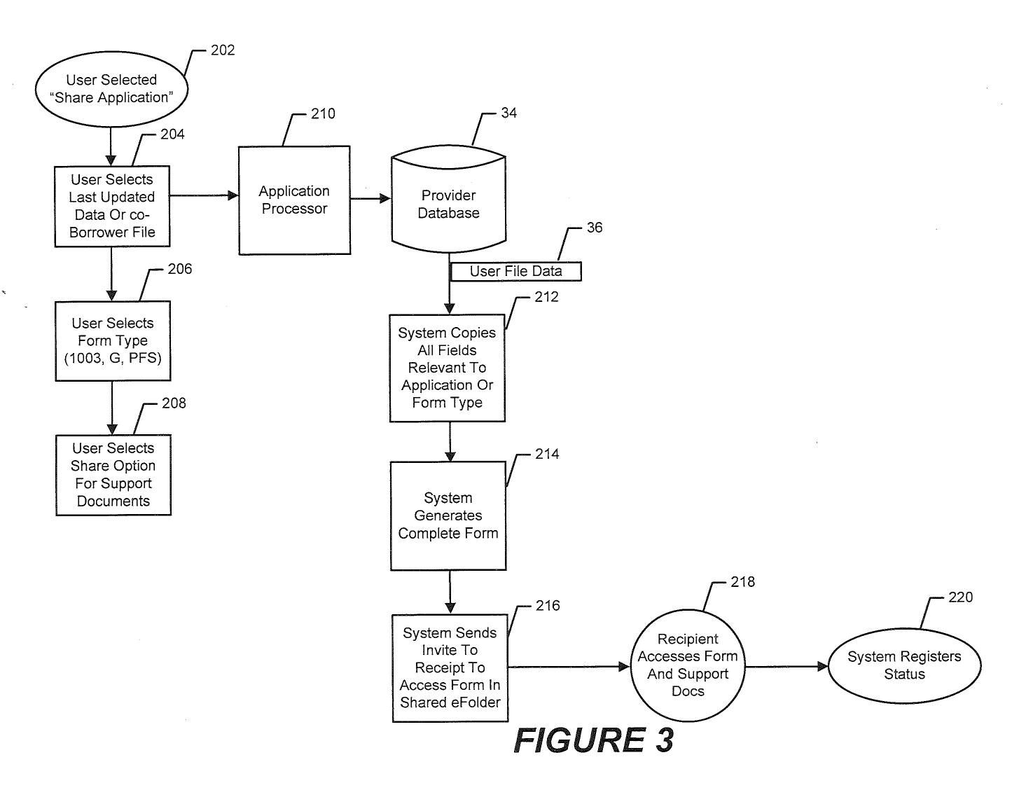

Reference is now made to FIG. 3, which is a block diagram illustrating operations and structures for applicant actions corresponding to an application according to some embodiments of the present invention. In some embodiments, a user may select an “share application” operation for an underlying credit application (block 202). The user may select the most recently updated data and/or co-borrower file (block 204). A user form may be selected (block 206). In some embodiments, a share option may be selected corresponding to one or more of the support documents (block 208). Once the user inputs are selected, the data may be processed by an application processor 210, which may populate a provider database 34 with the information for the user data file 36.

Based on the contents of the user data file 36, data corresponding to all of the data fields that are relevant to the application type may be identified and/or copied (block 212). A complete application form may be generated (block 214). An invitation may be sent to the co-borrower (recipient) including access to the documents and/or the complete application form in a shared application electronic document folder (block 216). The co-borrower (recipient) may access the complete application form and/or the support documents (block 218). The status of the application as a shared application may be registered (block 220).

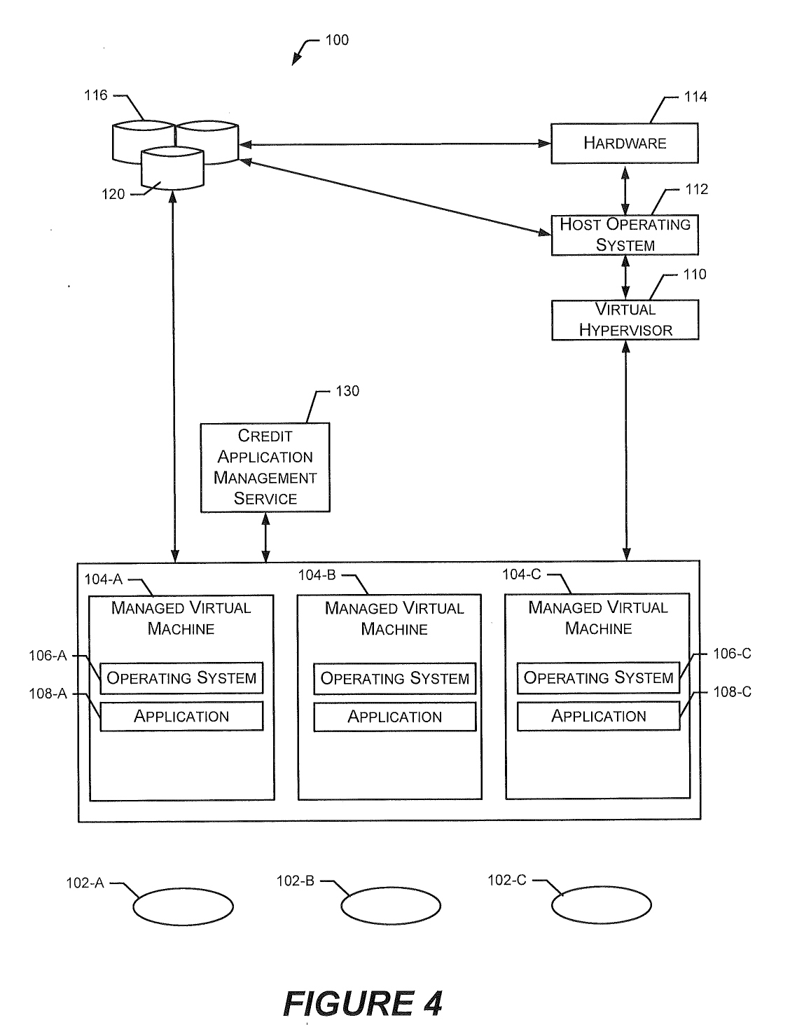

Reference is now made to FIG. 4, which illustrates a virtual computing environment according to some embodiments of the present inventive subject matter. The computer system 100 generally hosts and manages one or more virtual machines (hereafter managed virtual machine, or managed machine), each of which runs a guest operating system 106 and application 108. The computing needs of users 102 (e.g., humans and/or other virtual/non-virtual machines) drive the functionality of the virtual machines 104. A virtual hypervisor 110 can provide an interface between the virtual machines 104 and a host operating system 112 and allow multiple guest operating systems 106 and associated applications 108 to run concurrently. The host operating system 112 handles the operations of a hardware platform 114 capable of implementing virtual machines 104. A data storage space 116 may be accessed by the host operating system 112 and is connected to the hardware platform 114.

The hardware platform 114 generally refers to any computer system capable of implementing virtual machines 104, which may include, without limitation, a mainframe computer platform, personal computer, mobile computer (e.g., tablet computer), server, wireless communication terminal (e.g., cellular data terminal), or any other appropriate program code processing hardware. The hardware platform 114 may include computer resources such as a processing circuit(s) (e.g., central processing unit, CPU); networking controllers; communication controllers; a display unit; a program and data storage device; memory controllers; input devices (such as a keyboard, a mouse, etc.) and output devices such as printers. The processing circuit(s) is configured to execute computer program code from memory device(s), described below as a computer readable storage medium, to perform at least some of the operations and methods described herein, and may be any conventional processor circuit(s), including, but not limited to the AMD Athlon™ 64, or Intel® Core™ Duo, among others.

The hardware platform 114 may be further connected to the data storage space 116 through serial or parallel connections. The data storage space 116 may be any suitable device capable of storing computer-readable data and program code, and it may include logic in the form of disk drives, random access memory (RAM), or read only memory (ROM), removable media, or any other suitable memory component. According to the illustrated embodiment, the host operating system 112 functionally interconnects the hardware platform 114 and the users 102 and is responsible for the management and coordination of activities and the sharing of the computer resources.

Although some embodiments of the computer system 100 can be configured to operate as a computer server, the computer system 100 is not limited thereto and can be configured to provide other functionality, such as data processing, communications routing, etc.

Besides acting as a host for computing applications that run on the hardware platform 114, the host operating system 112 may operate at the highest priority level in the system 100, executing instructions associated with the hardware platform 114, and it may have exclusive privileged access to the hardware platform 114. The priority and privileged access of hardware resources affords the host operating system 112 exclusive control over resources and instructions, and may preclude interference with the execution of different application programs or the operating system. The host operating system 112 can create an environment for implementing a virtual machine, hosting the “guest” virtual machine. One host operating system 112 is capable of implementing multiple isolated virtual machines simultaneously.

A virtual hypervisor 110 (which may also be known as a virtual machine monitor or VMM) may run on the host operating system 112 and may provide an interface between the virtual machine 104 and the hardware platform 114 through the host operating system 112. The virtual hypervisor 110 virtualizes the computer system resources and facilitates the operation of the virtual machines 104. The hypervisor 110 may provide the illusion of operating at the highest priority level to the guest operating system 106. However, the virtual hypervisor 110 can map the guest operating system's priority level to a priority level lower than the top most priority level. As a result, the virtual hypervisor 110 can intercept the guest operating system 106, and execute instructions that require virtualization assistance. Alternatively, the virtual hypervisor 110 may emulate or actually execute the instructions on behalf of the guest operating system 106. Software steps permitting indirect interaction between the guest operating system 106 and the physical hardware platform 114 can also be performed by the virtual hypervisor 110.

When operating in a virtualized environment, the virtual machines 104 present a virtualized environment to the guest operating systems 106, which in turn provide an operating environment for applications 108 and other software constructs.

Applications 108 that are implemented on the virtual machines 104 may be configured to access one or more data sources in accordance with the functions thereof. As discussed herein by way of example, a data source may be a file, however, the disclosure is not so limited. For example, database applications and/or applications that operate, at least in part, using data sources such as database files, may rely on access to one or more database files to perform the requisite operations. In some embodiments, such access may further include one or more settings that determine or identify a portion, format, location, path, version or other attribute of the file being accessed. For example, an access request corresponding to a database file may include query terms, among others. In some embodiments, an access request corresponding to a database file may be directed to a database 120 that may be included in or provided in addition to the data storage space 116.

A credit application management service 130 that is operable to perform operations and functions described herein may be provided to manage credit applications of various users 102. As described herein credit application management may include requesting and receiving data corresponding to a user for a user data file,

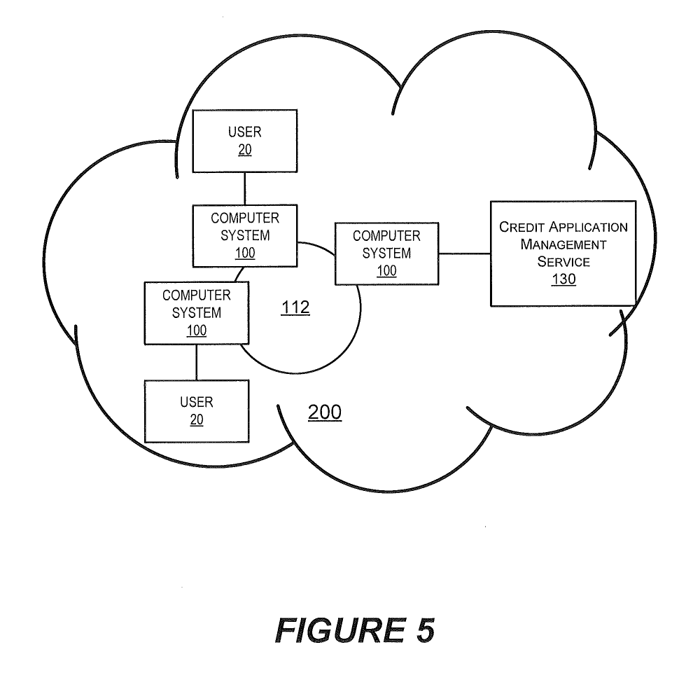

Reference is now made to FIG. 5, which illustrates a virtual computing environment according to some embodiments of the present inventive subject matter. A virtual computing environment 200 (referred to generally as cloud 200) may include one or more computer systems 100 (referred to as server systems) that may include one or more electronic computing devices operable to receive, transmit, process, and store data. For example, the servers in the cloud 200 may include one or more general-purpose personal computers, workstations, server computers, server pools, or any other suitable devices. In certain embodiments, the cloud 200 may include a web server. In short, the cloud 200 may include any suitable combination of software, firmware, and hardware.

The plurality of server systems 100 may be communicatively coupled via a network 112. The network 112 facilitates wireless and/or wireline communication, and may communicate using, for example, IP packets, Frame Relay frames, Asynchronous Transfer Mode (ATM) cells, voice, video, data, and other suitable information between network addresses. The network 112 may include one or more local area networks (LANs), radio access networks (RANs), metropolitan area networks (MANs), wide area networks (WANs), all or a portion of the global computer network known as the Internet, and/or any other communication system or systems at one or more locations. Although referred to herein as “server systems”, it will be appreciated that any suitable computing device may be used. A network address may include an alphabetic and/or numerical label assigned to a device in a network. For example, a network address may include an IP address, an IPX address, a network layer address, a MAC address, an X.25/X.21 address, and/or a mount point in a distributed file system, among others.

While FIG. 5 illustrates a physical configuration of servers within a cloud 200, a computer system 100 may include a logical grouping of virtual machines 104 within a virtualization environment in the cloud 200. Although not illustrated herein, the virtual machines 104 in the cloud can be organized and managed in clusters, which may also referred to herein as “grids”. A virtualization environment in the cloud 200 may be managed by a single hypervisor 110, or a set of hypervisors 110.

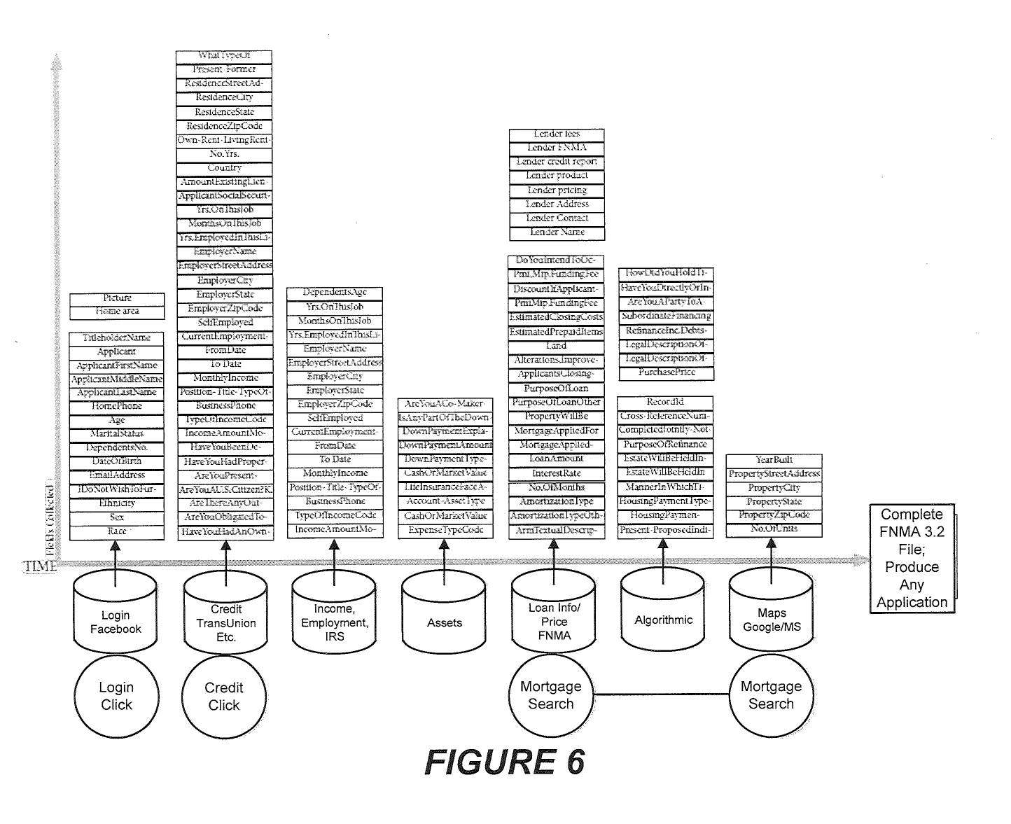

Reference is now made to FIG. 6, which is a block diagram illustrating an example list of data fields that may be populated and corresponding prospective data sources and/or data types that may be used in some embodiments of the present inventive subject matter.

Virtual machines can be deployed in particular virtualization environments and organized to increase the efficiency of operating and/or managing a virtual computing environment. For example, virtual machines may be grouped into clusters in order to provide load balancing across multiple servers.

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

Some embodiments provide that one or more of the programs may be executed during a portion of execution of another one of the programs in the corresponding process operation.

The flowchart and block diagrams in the figures illustrate the architecture, functionality, and operation of possible implementations of systems, methods and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. The aspects of the disclosure herein were chosen and described in order to best explain the principles of the disclosure and the practical application, and to enable others of ordinary skill in the art to understand the disclosure with various modifications as are suited to the particular use contemplated.

The foregoing is illustrative of the present invention and is not to be construed as limiting thereof. Although a few embodiments of the present invention have been described, those skilled in the art will readily appreciate that many modifications are possible in the embodiments without materially departing from the novel teachings and advantages of the present invention. Accordingly, all such modifications are intended to be included within the scope of the present invention as defined in the claims. Therefore, it is to be understood that the foregoing is illustrative of the present invention and is not to be construed as limited to the embodiments disclosed herein, and that modifications to the disclosed embodiments, as well as other embodiments, are intended to be included within the scope of the appended claims. The present invention is defined by the following claims.

What is claimed is:

1. A computer system, comprising:
a processor; and
a memory coupled to the processor, the memory comprising computer readable program code embodied therein that, when executed by the processor, causes the processor to perform operations comprising:
aggregating user information through a plurality of validated external sources; and
generating a credit application having a standard format using the user information.

2. The computer system according to claim 1, wherein aggregating the user information comprises receiving, via a user interface, a user input that includes less than three fields of data or that comprises a social network login.

3. The computer system according to claim 2, further comprising transmitting a request by the computer system to the social network to receive personal user data from the social network.

4. The computer system according to claim 2, wherein aggregating the user information comprises:
aggregating personal data in a primary aggregating operation corresponding to user provided information or social network information; and
aggregating secondary data in a secondary aggregating operation that is different from the primary aggregating operation.

5. The computer system according to claim 4, wherein aggregating secondary data in a secondary aggregating operation comprises:
requesting data from a plurality of external data sources, further comprising sorting and matching aggregated data into standard data fields.

6. The computer system according to claim 4, further comprising, before generating the credit application:
generating a user data file corresponding to the aggregated data; and
storing the user data file in a provider data repository.

7. The computer system according to claim 6, wherein generating the credit application comprises receiving, via a user interface, a form selection input corresponding to which type of a plurality of forms to use for the credit application.

8. The computer system according to claim 7, further comprising:
generating a form corresponding to a certification form responsive to receiving the form selection input; and
transmitting, displaying and/or printing the certification form.

9. The computer system according to claim 6, wherein generating the credit application comprises receiving, via a user interface, an application selection input corresponding to which of a plurality of credit application types to generate for the credit application, further comprising:
generating the credit application responsive to receiving the application selection input; and
transmitting, printing and/or displaying the generated credit application.

10. The computer system according to claim 6, wherein generating the credit application comprises:
receiving an affordability analysis input from the user via a user interface; and
generating an affordability analysis corresponding to the user data file and a credit application type.

11. The computer system according to claim 10, wherein the affordability analysis includes at least one suggestion for improving an affordability characteristic, further comprising printing and/or displaying the at least one suggestion.

12. The computer system according to claim 6, further comprising:
receiving, via a graphical user interface, a user input to share the credit application;
sending an invitation to a co-borrower to join the credit application;
receiving co-borrower data; and
merging the user information and the co-borrower data to generate a shared credit application.

13. The computer system according to claim 1, further comprising a mobile terminal comprising a mobile terminal processor; and
a mobile terminal memory coupled to the mobile terminal processor, the mobile terminal memory comprising computer readable program code embodied therein that, when executed by the processor, causes the processor to perform one or more operations of claim 1.

14. A method, comprising:
aggregating user information through a plurality of validated external sources; and
generating a credit application having a standard format using the user information,
wherein aggregating user information and generating the credit application are performed using at least one processor.

15. The method according to claim 14, wherein aggregating the user information comprises receiving, via a user interface, a user input that includes less than three fields of data or that comprises a social network login.

16. The method according to claim 15, further comprising transmitting a request by the computer system to the social network and receiving personal user data from the social network responsive to the request.

17. The method according to claim 15, wherein aggregating the user information comprises:
aggregating personal data in a primary aggregating operation corresponding to user provided information or social network information; and
aggregating secondary data in a secondary aggregating operation that is different from the primary aggregating operation and that includes transmitting requests and receiving data from a credit data repository, the Internal Revenue Service and/or an Office of Foreign Asset Control data repository.

18. The method according to claim 17, further comprising, before generating the credit application:
generating a user data file corresponding to the aggregated data; and
storing the user data file in a provider data repository.

19. The method according to claim 17, wherein generating the credit application comprises receiving, via a user interface, a form selection input corresponding to which type of a plurality of forms to use for the credit application.

20. The method according to claim 19,
wherein receiving the form selection input comprises receiving a first form selection input and a second form selection input, further comprising:
generating a first form corresponding to a first certification form responsive to receiving the first form selection input;
generating a second form that is different from the first form and that corresponds to a second certification form that is different from the first certification form responsive to receiving the second form selection input; and
transmitting, displaying and/or printing the first and/or second certification form.

21. The method according to claim 19, wherein generating the credit application comprises receiving, via a user interface, an application selection input corresponding to which one of a plurality of credit application types to generate for the credit application, further comprising:
generating the credit application responsive to receiving the application selection input; and
transmitting, printing and/or displaying the generated credit application.

22. The method according to claim 14, wherein generating the credit application comprises:
receiving an affordability analysis input from the user via a user interface; and
generating an affordability analysis corresponding to the user data file and a credit application type, and
wherein the affordability analysis includes at least one suggestion for improving an affordability characteristic, further comprising printing and/or displaying the at least one suggestion.

23. The method according to claim 14, further comprising:
receiving, via a graphical user interface, a user input to share the credit application;
sending an invitation to a co-borrower to join the credit application;
receiving co-borrower data; and
merging the user information and the co-borrower data to generate a shared credit application.

24. A computer program product comprising:
a computer readable storage medium having computer readable code embodied in the medium, the computer code comprising:
computer readable code to perform operations comprising:
aggregating user information through a plurality of validated external sources;
generating a user data file corresponding to the aggregated data;
generating a plurality of different credit applications corresponding to different types of goods to be purchased using credit;
receiving an affordability analysis input from the user;
generating an affordability analysis corresponding to the user data file, the affordability analysis input and a credit application type, wherein the affordability analysis includes at least one suggestion for improving an affordability characteristic;
storing the user data file, at least one credit application and the affordability analysis in a provider data repository; and
transmitting, printing and/or displaying the generated credit application and/or the affordability analysis.
